(19) United States
(12) Patent Application Publication
(10) Pub. No.: US 2007/0114938 A1
(43) Pub. Date: May 24, 2007

(54) Plasma display panel with increased integration degree of pixels

(76) Inventor: Sanghoon Lim, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/603,193

(22) Filed: Nov. 22, 2006

(30) Foreign Application Priority Data
Nov. 22, 2005 (KR) 10-2005-0111911

(51) Int. Cl. H01J 17/02

(52) U.S. Cl. 313/610

(57) ABSTRACT

A plasma display panel includes two substrates, a plurality of barrier ribs defining a plurality of discharge cells between the two substrates, a plurality of pixels rows having a plurality of pixels with three discharge cells arranged in a triangular shape between the two substrates, and a plurality of address electrodes between the two substrates, such that an average of 1.5 address electrodes are assigned to each pixel in the pixels row.

### BACKGROUND OF THE INVENTION

1. Field of the Invention

The present invention relates to a plasma display panel. More particularly, the present invention relates to a plasma display panel having enhanced integration degree of pixels.

2. Description of the Related Art

In general, a plasma display panel (PDP) refers to a flat display device capable of displaying images using gas discharge phenomenon, thereby providing superior display characteristic, such as high brightness and contrast, lack of residual image, and wide viewing angles.

The conventional PDP may include two substrates with a plurality of discharging electrodes therebetween, i.e., a plurality of sustain and address electrodes, a plurality of pixels having phosphorescent layers, and barrier ribs between the two substrates to separate the plurality of phosphorescent layers. When a predetermined amount of electricity is applied to the electrodes, a sustain discharge may be generated to trigger ultraviolet (UV) emission and, thereby, to excite the phosphorescent layers to emit light and form visible images.

The conventional PDP may be driven either by a direct current (DC) voltage or an alternating current (AC) voltage. When the conventional PDP is driven by an AC voltage, the driving electrodes may be coated with a dielectric layer to improve the electrostatic capacity thereof. Further, due to a reduced current flow through the driving electrodes, the exposure of the electrodes to discharge is minimized, thereby providing improved lifespan thereto. When the conventional PDP is driven by an AC surface discharge, as opposed to face-type discharge, a plurality of parallel address electrodes may be positioned vertically between the two substrates, and a plurality of common and scan electrodes, e.g., pairs of sustain and display electrodes, may be positioned parallel to one another in alternating horizontal stripe-pattern between the two substrates.

A matrix of pixel units may be formed between the plurality of address electrodes and pairs of sustain and display electrodes, while each pixel unit may include discharge cells emitting separate visible light beams. The discharge cells of each pixel unit may be sequentially arranged in stripe-shaped or circle-shaped structures, such that each pixel unit may overlap with three address electrodes. The arrangement and structure of pixel units may affect high definition and high brightness in a PDP. Accordingly, attempts have been made to increase the pixel unit density.

However, increase of pixel unit density may increase the number of required address electrodes. An increased number of address electrodes may reduce the distance therebetween and, therefore, increase the capacitance, the power consumption, and the heat release rate of the PDP, thereby reducing its signal transmittance. Additionally, an increased number of address electrodes may increase the cost and complexity of the manufacturing process due to additional required elements, e.g., tape carrier packages (TCP), and difficulty in designing an appropriate driving board.

Accordingly, there exists a need to improve the structure of the PDP in order to provide for an improved pixel unit density, while maintaining a reduced number of address electrodes.

### SUMMARY OF THE INVENTION

The present invention is therefore directed to a plasma display panel which substantially overcomes one or more of the disadvantages of the related art.

It is therefore a feature of an embodiment of the present invention to provide a plasma display panel capable of providing increased pixel unit density, while maintaining a reduced number of address electrodes.

It is another feature of an embodiment of the present invention to provide a plasma display panel capable of reducing power consumption and manufacturing costs.

At least one of the above and other features and advantages of the present invention may be realized by providing a plasma display panel, including two substrates, a plurality of barrier ribs between the two substrates, the plurality of barrier ribs defining a plurality of discharge cells, a plurality of pixels rows between the two substrates, each pixels row including a plurality of pixels, and each pixel having three discharge cells arranged in a triangular shape, and a plurality of address electrodes between the two substrates, wherein an average of 1.5 address electrodes are assigned to each pixel in the pixels row.

The three discharge cells of each pixel may be arranged in either a delta shape or a nabla shape to form a triangle, and the plurality of pixels may be positioned in the pixels row to have alternating delta shape and nabla shape discharge cells arrangement, such that two of the address electrodes may pass through each of the pixels.

The pixels row may include a first row and a second row of discharge cells, wherein the second row may be shifted horizontally with respect to the first row. Further, the three discharge cells of each pixel may emit three different colors and may be positioned in the first row and in the second row of the discharge cells, such that the second row of discharge cells may be shifted horizontally with respect to the first row of discharge cells by a ½ cycle.

The plurality of address electrodes may be perpendicular to the plurality of pixels rows. Further, the plurality of address electrodes and a plurality of vertical portions of the barrier ribs may be positioned alternately in each of the pixels rows.

The plasma display panel may further include at least one branch electrode electrically connected to each address electrode, the at least one branch electrode assigned to one discharge cell. The at least one branch electrode of each address electrode may extend from the address electrode toward a center of the overlapping discharge cell.

The plasma display panel may also include a plurality of sustain electrodes positioned perpendicularly to the address electrodes. The sustain electrodes may be positioned to have predetermined intervals therebetween. Further, the sustain electrodes may overlap with a plurality of horizontal portions of the barrier ribs. The plurality of sustain electrodes may include alternating scan and common electrodes.

Each pixel row may be assigned to one common electrode and one scan electrode. The common electrodes may include a first group of common electrodes and a second group of common electrodes, the first and second groups of common electrodes having different voltages.

The barrier ribs may be arranged in a skewed-grid shape. The discharge cells may have a hexagonal form or a rectangular form. The plasma display panel may further include a plurality of phosphorescent layers.

In another aspect of the present invention, there is provided a plasma display panel, including two substrates, a plurality of barrier ribs between the two substrates, the plurality of barrier ribs defining a plurality of discharge cells, a plurality of pixels rows between the two substrates, each pixels row including a plurality of pixels, and each pixel having three discharge cells arranged in a triangular shape, a plurality of address electrodes between the two substrates, and a plurality of sustain electrodes positioned perpendicularly to the address electrodes, wherein a ratio of a number of the address electrodes to a number of the sustain electrodes is about 3:4.

The three discharge cells of each pixel may be arranged in either a delta shape or a nabla shape to form a triangle, and the plurality of pixels may be positioned in the pixels row to have alternating delta shape and nabla shape discharge cells arrangement, such that two of the address electrodes may pass through each of the pixels. Additionally, each pixels row may include a first row and a second row of discharge cells, wherein the second row may be shifted horizontally with respect to the first row by a ½ cycle, and wherein the three discharge cells of each pixel may emit three different colors and may be positioned in the first row and in the second row of the discharge cells.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrate a perspective sectional view of a plasma display panel according to an embodiment of the present invention;

FIG. 2 illustrates a schematic plan view of a plasma display panel according to another embodiment of the present invention; and

FIG. 3 illustrates a schematic plan view of a plasma display panel according to another embodiment of the present invention.

### DETAILED DESCRIPTION OF THE INVENTION

Korean Patent Application No. 10-2005-0111911, filed on Nov. 22, 2005, in the Korean Intellectual Property Office, and entitled: “Plasma Display Panel for Increasing Integration Degree of Pixel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will further be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. Like reference numerals refer to like elements throughout.

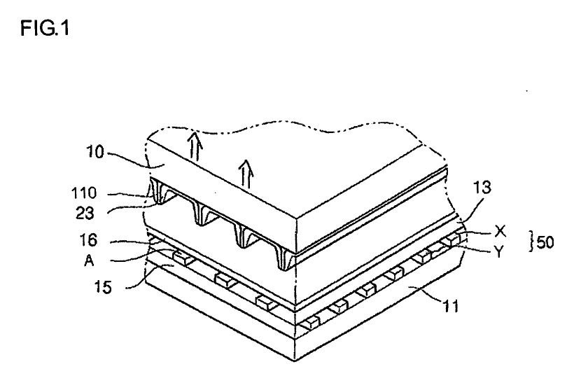

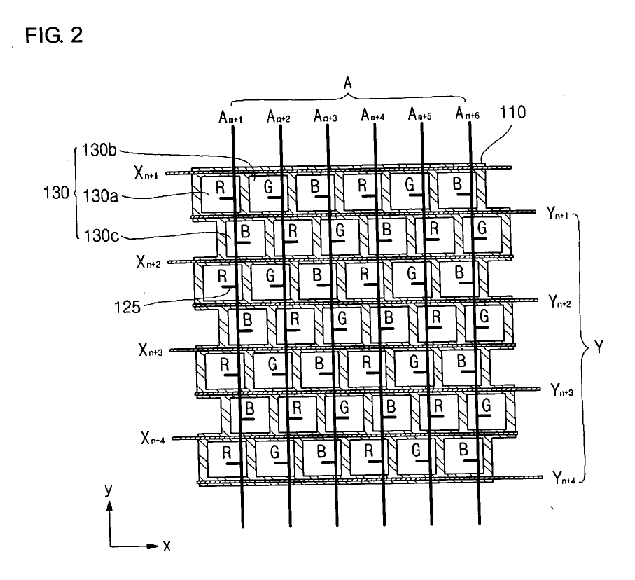

A PDP according to an embodiment of the present invention may include a front substrate, a rear substrate, a plurality of pixels disposed between the front and rear substrates, and a plurality of driving electrodes formed on the front substrate, the rear substrate, or both. More specifically, as illustrated in FIGS. 1-2, the PDP according to the present invention may include a front substrate 10, a rear substrate 11, a plurality of pixels 130, a plurality of sustain electrodes 50 formed on the rear substrate 11, a plurality of address electrodes A, and a plurality of ribs 110. It should be noted that the terms “pixel” and “pixel unit” are used interchangeably hereinafter.

The front substrate 10 may be formed of a single layer or multiple layers, wherein at least one layer may be any opaque material. For example, the front substrate 10 may include a metal layer coated with a dielectric layer. The rear substrate 11 may be formed parallel to the front substrate 10, such that additional layers, e.g., electrodes, dielectric layers, protective layers, pixel units and so forth, may be formed between the front and rear substrates 10 and 11, as will be discussed in more detail below.

Each pixel unit 130 of the PDP according to an embodiment of the present invention may include three discharge cells. In particular, as further illustrated in FIG. 2, each pixel unit 130 may include a first discharge cell 130a capable of emitting red (R) visible light, a second discharge cell 130b capable of emitting green (G) visible light, and a third discharge cell 130c capable of emitting blue (B) visible light. The discharge cells may have any convenient shape as determined by one of ordinary skill in the art, e.g., rectangular.

The discharge cells of each pixel unit 130 may be arranged in a triangular shape. In particular, each three discharge cells of one pixel unit 130 may be arranged in two parallel rows, such that two discharge cells may be formed in one row and one discharge cell may be formed in a parallel row. Further, each two adjacent pixel units 130 in a row may have an alternating orientation. In other words, if one pixel unit 130 has two discharging cells in an upper row and one discharging cell in a lower row, i.e., forming a nabla (∇), the adjacent pixel unit 130 in a same row may have one discharging cell in the upper row and two discharging cells in the lower row, i.e., forming a delta (Δ), such that the two adjacent pixel units 130 may form a uniform structure of two parallel rows. For example, as illustrated in FIG. 2, if one pixel unit 130 has the first and second discharging cells 130a and 130b in the upper row and the third discharging cell 130c in the lower row, the adjacent pixel unit 130 may have the first and second discharging cells 130a and 130b in the lower row and the third discharging cell 130c in the upper row.

In this respect, it should be noted that “rows” may refer to a direction along an x-axis, as illustrated in FIG. 2. This orientation may be parallel-to a horizontal side of a screen. However, other orientations are not excluded from the scope of the present invention. It should further be noted that terminology such as “first” and “second” with respect to rows is employed to distinguish the rows and indicate their sequence.

The discharging cells may be disposed sequentially in any repetitive order along each row, such that a triangular shape of a pixel unit 130 having each of the first, second and third discharging cells 130a, 130b and 130c may be formed. For example, as illustrated in FIG. 2, the first, second and third discharging cells 130a, 130b and 130c may be disposed sequentially in a first row, while the third, first and second discharging cells 130c, 130a and 130b may be disposed sequentially in a second horizontal row, such that the third discharging cell 130c in the second row is shifted horizontally to be positioned symmetrically with respect to the first and second discharging cells 130a and 130b in the first row, i.e., a central vertical line crossing the third discharging cell 130c may align with a center of a vertical gap between the first and second discharge cells 130a and 130b. In other words, the second row may be shifted horizontally by a half cycle with respect to the first row, while a “cycle” may refer to a width of three discharge cells emitting three different colors along the x-axis.

The above described pixel unit 130 structure may be sequentially repeated. In other words, the delta-shaped pixel units 130 and the nabla-shaped pixel units 130 may be positioned alternately in a linear array to form a pixels row having two parallel rows of discharging cells, i.e., the first and second rows of discharge cells as described above.

The plurality of address electrodes A of the PDP according to an embodiment of the present invention may be formed in a stripe-like structure in a plane parallel to a plane of the pixel units 130 rows. Further, the plurality of address electrodes A may be formed in parallel to one another at a predetermined angel with respect to the linear array of pixel units 130 rows, e.g., perpendicularly to the linear array of pixel units 130.

The plurality of address electrodes A may be formed such that each address electrode A may overlap with one discharge cell in each row of discharge cells, e.g., address electrode Am+1 may overlap with the first discharge cell 130a in the first row. However, the structure of the discharge cells may be such that, for example, six address electrodes Am+1 . . . Am+6 may overlap with four pixel units 130 formed in the first two rows, as illustrated in FIG. 2. Accordingly, an average number of address electrodes A assigned to each pixel unit 130 may be 1.5, i.e., the average number of address electrodes A assigned to each pixel unit 130 may be reduced by two as compared with the conventional art.

The barrier ribs 110 of the PDP according to an embodiment of the present invention may be formed in any shape, e.g., have vertical and horizontal portions, on an inner surface of the front substrate 10 or the rear substrate 11, i.e., positioned between the two substrates, by any method known in the art, e.g., lithography, photolithography, and so forth. In particular the barrier ribs 110 may be formed in a plane perpendicular to a plane of the front and the rear substrates 10 and 11 of the PDP and therebetween to define a plurality of discharge cells, such that phosphor layers 23 may be laminated on the an inner surface of each discharge cell, i.e., sidewalls of the barrier ribs 110 and a surface the barrier ribs 100 are positioned on. More specifically, the barrier ribs 110 may form a skewed grid structure, as illustrated in FIG. 2, such that the address electrodes A may pass between the vertical portions of the barrier ribs 110, i.e., along a y-axis, without overlapping therewith. In other words, each address electrode A may be positioned between two vertically formed portions of the barrier ribs 110.

The sustain electrodes 50 of the PDP according to an embodiment of the present invention may include a plurality of pairs of common electrodes X and scan electrodes Y. In particular, the sustain electrodes 50 may be formed of metal or of a transparent conductive layer, e.g., indium-tin-oxide (ITO), on the rear substrate 11. More specifically, the pairs of common electrodes X and scan electrodes Y may be formed in an alternating stripe-like structure and parallel to one another, i.e., alternately disposing a common electrode X and a scan electrode Y perpendicularly to a direction of the address electrodes A. In particular, the common electrodes X and scan electrodes Y may be formed in parallel to the rows of discharge cells and perpendicularly to the vertically formed portions of the barrier ribs 110, such that one sustain electrode may be positioned between two rows of discharge cells, as illustrated in FIG.2. For example, sustain electrode Yn+1 may be positioned between the first and second discharge cell rows, while the sustain electrode Xn+2 may be positioned between the second and third discharge cell rows. For example, negative voltage may be applied to any scan electrode Y, e.g., Yn+1, and positive voltage may be applied to any address electrode A, e.g., Am+1, to trigger discharge in two vertical discharge cells positioned adjacent to the scan electrode Y, e.g., the first discharge cell 130a and the third discharge cell 130c.

Without intending to be bound by theory, it is believed that employing two types of sustain electrodes 50, i.e., pairs of common electrodes X and scan electrodes Y, on the barrier ribs 110 may provide a longer gap and a face discharge type PDP, thereby increasing the distance between discharge electrodes and overall discharge efficiency.

It should be noted, however, that when a discharge is triggered simultaneously in two vertically adjacent discharge cells, the two discharge cells may not be driven independently, thereby reducing vertical resolution of the PDP.

Accordingly, an alternative lightening of surface (ALIS) method may be applied. For example, the scan electrodes Y may be divided into a first scan electrode group Y2n+1 and a second scan electrode group Y2n, such that different voltages may be applied to each group to provide ALIS driving. Other known methods of ALIS may be employed in the present invention as determined by one of ordinary skill in the art. However, since the ALIS method is well known, detailed description thereof will be omitted herein.

A first dielectric layer 15 and/or a protective layer 16, e.g., magnesium oxide (MgO), may be disposed on the sustain electrodes 50, as illustrated in FIG. 1, by any method known in the art, e.g., sputtering, deposition, and so forth. Additionally, a second dielectric film 13 may be positioned on the first dielectric film 15, such that the address electrodes A may be positioned therebetween. The protective film 16 may be formed on the second dielectric film 13. Accordingly, the PDP according to an embodiment of the present invention may have a layered structure, such that the front and rear substrates and may have layers of electrodes, barrier ribs, dielectric materials, and protective materials therebetween. Such structure and methods of manufacturing thereof are well-known in the art, and therefore, will not be described in detail herein.

The PDP according to an embodiment of the present invention may further include at least one branch electrode 125 electrically connected to each address electrode A in order to increase an area of a display and/or address discharge and allowing greater accuracy. For example, each branch electrode 125 may be formed to overlap with a respective discharge cell, such that the branch electrode 125 may extend from the respective address electrode A towards a center of the respective discharge cell. Accordingly, as illustrated in FIG. 2, each two vertically adjacent branch electrodes 125 in communication with a respective address electrode A may be directed in opposite directions. In this respect, it should be noted that the shape, number, and angle with respect to the main address electrode A of the branch electrodes 125 may vary.

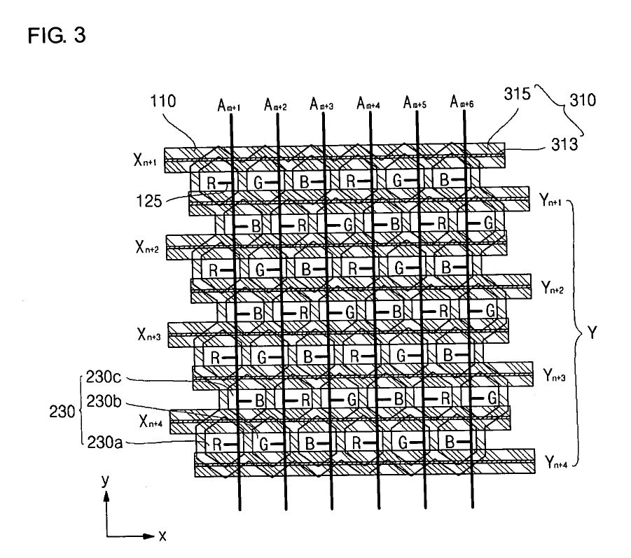

In another embodiment of the present invention as illustrated in FIG. 3, the PDP is similar to the PDP described with respect to FIG. 2, with the exception that a first, a second, and a third discharge cell 230a, 230b, and 230c, respectively, of each pixel unit 230 may have a hexagonal form. Accordingly, only details that may be distinguishable from the previous embodiment will be described hereinafter.

Each sustain electrode X and Y may have a predetermined width and be made of any suitable material as determined by one of ordinary skill in the art. In particular, each sustain electrode may include a bus electrode 313 and a transparent electrode 315, as illustrated in FIG. 3. The transparent electrode 315 may be in contact with the bus electrode 313 and have a sufficient width to overlap with portions of two rows of discharge cells. For example, as illustrated in FIG. 3, the sustain electrode Yn+1 may have a transparent electrode 315 overlapping with a lower portion of the first row of discharge cells and with an upper portion of the second row of discharge cells.

The formation of the discharge cells and the address electrodes A may be similar to the formation described previously with respect to FIG. 2. Accordingly, the average number of address electrodes A assigned to each pixel unit 230 may be 1.5 as well.

Additionally, in both embodiments described above, sixteen pixel units are illustrated in FIGS. 2 and 3, i.e., four pixel units in each row and column. Since a total number of address electrodes A illustrated in each one of FIGS. 2 and 3 is six, and a total number of scan electrodes Y illustrated in each one of FIGS. 2 and 3 is four, a ratio of the number of the address electrodes A to the number of the scan electrodes Y is 3:2. Further, a ratio of the number of the address electrodes A with respect to a number of the sustain electrodes X and Y is 3:4.

### EXAMPLES

The embodiments of the present invention were compared to conventional PDPs having different configurations of barrier ribs and electrodes. The comparison parameters included number of address electrodes, number of TCPs, number of scan electrodes and scan driving circuits, the required number of address buffer boards, the address power consumption, heat generation per address circuit, and the critical power (instantaneous power) applied to each address circuit. The power consumption, heat generation, and critical power for each address electrode were estimated at the most conservative case scenario, i.e., application of alternating on/off voltage to the address electrodes to provide interference therebetween in order to provide increased power consumption and heat generation.

For the purpose of the examples, the power employed for driving the address electrodes was assumed to be fully consumed as the switching was made, and the voltage level for driving the address electrodes was fixed for all cases.

Theoretically, the current flow increases as the distance between the address electrodes decrease. Further, the power consumption is proportional to the capacitance, and the square of voltage difference between the electrodes is nearly disposed.

Results of the comparison are summarized in Table 1 below.

TABLE 1

| | | | | Power | | | | |
|---|---|---|---|---|---|---|---|---|
| | Number of | | Number of | consumption for | Heat generation | Critical power | Number of | Number of |
| | address | | required | address | per address | per address | scan | scan driving |
| Type/item | electrodes | Number of TCP | buffer board | electrodes | electrode | buffer board | electrodes | chips |
| Present | 2880 | 30 | 2 | 0.69 | 0.49 | 0.35 | 1080 | 17 |
| invention | | | | | | | | |
| FHD, Dual | | | | | | | | |
| Stripe | 5760 | 60 | 2 | 1.39 | 0.49 | 0.7 | 1080 | 17 |
| FHD, Dual | | | | | | | | |
| Hexagonal | 5760 | 60 | 2 | 1.39 | 0.49 | 0.7 | 1080 | 17 |
| discharge | | | | | | | | |
| FHD, Dual | | | | | | | | |
| Hexagonal | 5760 | 30 | 1 | 2.78 | 1.98 | 1.41 | 1080 | 17 |
| meander | | | | | | | | |
| FHD, Single | | | | | | | | |
| Hexagonal | 4098 | 21 | 1 | 1 | 1 | 1 | 768 | 12 |
| meander | | | | | | | | |
| 1366*768, | | | | | | | | |
| Single | | | | | | | | |
| Hexagonal | 3840 | 20 | 1 | 0.82 | 0.88 | 0.94 | 720 | 12 |
| meander | | | | | | | | |
| 1280*720, | | | | | | | | |
| Single | | | | | | | | |

As illustrated in Table 1, the number of address electrodes in a hexagonal meander type display is 4089 and the number of address electrodes in new delta type, i.e., according to the present invention, is 2880. Accordingly, when a same size of panel is used, the power consumption is decreased by 2880/4089=0.69.

Therefore, as can be seen in Table 1, the present invention has a reduced number of address electrodes as compared to conventional art, while exhibiting reduced power consumption per address electrode, reduced heat generation per address electrode, and reduced critical power per address electrode. Accordingly, the PDP according to an embodiment of the present invention may have a reduced number of address electrodes as compared to a conventional PDP having the same horizontal resolution and number of driving circuit chips, whereby overall power consumption and heat release rate are reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
two substrates;
a plurality of barrier ribs between the two substrates, the plurality of barrier ribs defining a plurality of discharge cells;
a plurality of pixels rows between the two substrates, each pixels row including a plurality of pixels, and each pixel having three discharge cells arranged in a triangular shape; and
a plurality of address electrodes between the two substrates, wherein an average of 1.5 address electrodes are assigned to each pixel in the pixels row.

2. The plasma display panel as claimed in claim 1, wherein the three discharge cells of each pixel are arranged in either a delta shape or a nabla shape to form a triangle, and wherein the plurality of pixels are positioned in the pixels row to have alternating delta shape and nabla shape discharge cells arrangement, and wherein two of the address electrodes pass through each of the pixels.

3. The plasma display panel as claimed in claim 1, wherein the pixels row includes a first row and a second row of discharge cells, the second row is shifted horizontally with respect to the first row.

4. The plasma display panel as claimed in claim 3, wherein the three discharge cells of each pixel emit three different colors and are positioned in the first row and in the second row of the discharge cells, and wherein the second row of discharge cells is shifted horizontally with respect to the first row of discharge cells by a ½ cycle.

5. The plasma display panel as claimed in claim 1, wherein the plurality of address electrodes is perpendicular to the plurality of pixels rows.

6. The plasma display panel as claimed in claim 1, wherein the plurality of address electrodes and a plurality of vertical portions of the barrier ribs are positioned alternately in each of the pixels rows.

7. The plasma display panel as claimed in claim 1, further comprising at least one branch electrode electrically connected to each address electrode, the at least one branch electrode assigned to one discharge cell.

8. The plasma display panel as claimed in claim 7, wherein the at least one branch electrode of each address electrode extends from the address electrode toward a center of the overlapping discharge cell.

9. The plasma display panel as claimed in claim 1, further comprising a plurality of sustain electrodes positioned perpendicularly to the address electrodes.

10. The plasma display panel as claimed in claims 9, wherein the sustain electrodes are positioned to have predetermined intervals therebetween.

11. The plasma display panel as claimed in claim 10, wherein the sustain electrodes overlap with a plurality of horizontal portions of the barrier ribs.

12. The plasma display panel as claimed in claim 10, wherein the plurality of sustain electrodes includes alternating scan and common electrodes.

13. The plasma display panel as claimed in claim 12, wherein each pixels row is assigned to one common electrode and one scan electrode.

14. The plasma display panel as claimed in claim 12, wherein the common electrodes include a first group of common electrodes and a second group of common electrodes, the first and second groups of common electrodes having different voltages.

15. The plasma display panel as claimed in claim 1, wherein the barrier ribs are arranged in a skewed-grid shape.

16. The plasma display panel as claimed in claim 1, wherein the discharge cells have a hexagonal form or a rectangular form.

17. The plasma display panel as claimed in claim 1, further including a plurality of phosphorescent layers.

18. A plasma display panel, comprising:
two substrates;
a plurality of barrier ribs between the two substrates, the plurality of barrier ribs defining a plurality of discharge cells;
a plurality of pixels rows between the two substrates, each pixels row including a plurality of pixels, and each pixel having three discharge cells arranged in a triangular shape;
a plurality of address electrodes between the two substrates; and
a plurality of sustain electrodes positioned perpendicularly to the address electrodes, wherein a ratio of a number of the address electrodes to a number of the sustain electrodes is about 3:4.

19. The plasma display panel as claimed in claim 18, wherein the three discharge cells of each pixel are arranged in either a delta shape or a nabla shape to form a triangle, and wherein the plurality of pixels are positioned in the pixels row to have alternating delta shape and nabla shape discharge cells arrangement, and wherein two of the address electrodes pass through each of the pixels.

20. The plasma display panel as claimed in claim 18, wherein each pixels row includes a first row and a second row of discharge cells, the second row is shifted horizontally with respect to the first row by a ½ cycle, and wherein the three discharge cells of each pixel emit three different colors and are positioned in the first row and in the second row of the discharge cells.
